(19) United States
(12) Patent Application Publication
(10) Pub. No.: US 2010/0192789 A1
(43) Pub. Date: Aug. 5, 2010

(54) SILK SCREEN PRINTING MACHINE AND ITS LOCKING DEVICE

(75) Inventor: King Tim Tse, Fo Tan Shatin Hong Kong (CN)

Correspondence Address: LADAS & PARRY LLP, 224 SOUTH MICHIGAN AVENUE, SUITE 1600, CHICAGO, IL, 60604, US

(73) Assignee: HOT WING ENGINEERING LTD., Fo Tan Shatin Hong Kong (CN)

(21) Appl. No.: 12/677,138

(22) PCT Filed: Sep. 10, 2007
(86) PCT No.: PCT/CN2007/002677

§ 371 Date: Mar. 9, 2010

(51) Int. Cl. B41L 13/18; B05C 17/08

(52) U.S. Cl. 101/123; 101/126

(57) ABSTRACT

A screen printing machine and its locking device are disclosed. The screen printing device comprises a printing frame for holding printing stocks, a screen frame for supporting a screen and a squeegee; and at least one locking device including a first electromagnetic member mounted on one of the printing frame and the screen frame and connected to a power source and an attracted member mounted on the other one of the printing frame and the screen frame. When the screen frame is closed to the printing frame, the power source supplies power to the first electromagnetic member to enable the first electromagnetic member to attract the attracted member; when the printing is finished, the power source is turned off which makes the attraction of the first electromagnetic member to the attracted member disappear, and the printing frame and the screen frame are unlocked.

### FIELD OF THE INVENTION

The present invention generally relates to a screen printing machine, and more particularly relates to a locking device used in the screen printing machine.

### BACKGROUND OF THE INVENTION

As it could be applied to various printing stocks, screen printing is also called as universal printing. Therefore, the screen printing is more and more widely used in a variety of fields, such as business, advertising industry, decoration industry, culture industry, construction industry, publishing industry, dyeing and printing industry, electronics industry, etc.

A traditional screen printing machine mainly comprises a printing frame and a screen frame. The printing frame and the screen frame may be movable with respect to each other, which enable the opening or closing of the screen frame with respect to the printing frame. The printing frame is used to hold printing stocks, while the screen frame is used to support a screen and a squeegee. Before printing is started, the screen frame is opened with respect to the printing frame. Thus, the printing stocks and/or the screen could be changed. Next, the screen frame is moved towards the printing frame to be closed with respect to the latter. At this time, the squeegee starts to move along the screen to transferred printing ink on the screen to the printing stocks through openings of the screen. After printing is completed, the screen frame is moved away from the printing frame, and then the printing stocks could be taken off from the printing frame. According to the movement manner between the printing frame and the screen frame, the screen printing machine could be of a vertical elevating type, a hinged type, an inclined elevating type or a horizontal movement type.

In order to improve printing quality by enhancing the register accuracy during overprinting, the locking force between the printing frame and screen frame should be large enough in course of printing. However, most of the existing screen printing machines available on the market generate locking force by means of the weight of the screen frame, but such locking force is not sufficient for high quality printing. It is proposed to raise the locking force by increasing the weight of the screen frame. However, the inertia of the screen frame would also be increased accordingly during opening and closing the screen frame, which may affect the printing quality and the printing speed.

Although some of screen printing machines comprise mechanical locking devices to increase locking force, such mechanical locking devices could not control the timing for applying the locking force, and may apply locking force when parts of the operator's body are still between the printing frame and the screen frame. Thus, personal injures may be incurred. Otherwise, a lot of safety means should be provided to ensure personal safety, which not only increase the costs, but also impair the reliability of the screen printing machines.

To solve the above problems in the existing screen printing machine, a novel screen printing machine is proposed with which a novel locking device is provided. During printing, the locking device may ensure the locking force between the printing frame and the screen frame to be large enough. Thus, the printing quality and operation reliability could be ensured. It is also convenient for operation with a higher printing speed.

### SUMMARY OF THE INVENTION

To overcome the above-mentioned drawbacks, the main object of the present invention is to provide a screen printing machine which may comprise a printing frame for holding printing stocks; a screen frame for supporting a screen and a squeegee and being movable with respect to the printing frame to enable the opening and closing of the screen frame with respect to the printing frame; and at least one locking device including a first electromagnetic member and an attracted member, in which the first electromagnetic member is mounted on one of the printing frame and the screen frame and connected to a power source, while the attracted member is mounted on the other one of the printing frame and the screen frame in opposite to the first electromagnetic member. When the screen frame is closed with respect to the printing frame, the power source starts to supply power to the first electromagnetic member to enable the first electromagnetic member to generate an electromagnetic field and then generate an attractive force to the attracted member which locks the printing frame and the screen frame together. When the printing is finished, the power source stops supplying power to the first electromagnetic member which makes the attractive force of the first electromagnetic member to the attracted member disappear, and in turn the printing frame and the screen frame are unlocked.

Preferably, the locking device may further comprise a controller and a sensor. The sensor is provided to be triggered to send a signal to the controller when the screen frame is closed to the printing frame completely and the printing is finished; while the controller is connected to the power source and controls the power source to selectively supply power to the first electromagnetic member according to the signal received from the sensor.

The attracted member may be made of ferrite magnetic materials. Or, the attracted member could be a second electromagnetic member, in which the second electromagnetic member is connected to the power source in opposite phase with respect to the first electromagnetic member, and the power source could supply power to the first and second electromagnetic members simultaneously.

Preferably, the at least one locking device could be two or more locking devices provided along opposite sides between the printing frame and the screen frame.

In addition, the screen printing machine may further comprise a counter-weight for balancing part of the weight of the screen frame.

In another aspect, the present invention also provides a locking device used in a screen printing machine, in which the screen printing machine comprises a printing frame for holding printing stocks and a screen frame for supporting a screen and a squeegee and being movable with respect to the printing frame to enable the opening and closing of the screen frame with respect to the printing frame, and the locking device may comprise a first electromagnetic member mounted on one of the printing frame and the screen frame and connected to a power source; an attracted member mounted on the other one of the printing frame and the screen frame in opposite to the first electromagnetic member. When the screen frame is closed with respect to the printing frame, the power source starts to supply power to the first electromagnetic member to enable the first electromagnetic member to generate an electromagnetic field and then generate an attractive force to the attracted member which locks the printing frame and the screen frame together. When the printing is finished, the power source stops supplying power to the first electromagnetic member which makes the attractive force of the first electromagnetic member to the attracted member disappear, and in turn the printing frame and the screen frame are unlocked.

With the locking device of the present invention, a sufficient locking force could be provided between the screen frame and the printing frame, to improve printing quality. Besides, the locking device could be controlled automatically, which could not only lower intensity of labor, but also raise printing speed.

### BRIEF DESCRIPTION OF THE DRAWINGS

The present invention will be described in detail with reference to the accompanying drawings, in which,

FIG. 1 is a schematic view of a first embodiment of the screen printing machine according to the present invention; and

FIG. 2 is a schematic view of a second embodiment of the screen printing machine according to the present invention.

### DETAILED DESCRIPTION OF THE INVENTION

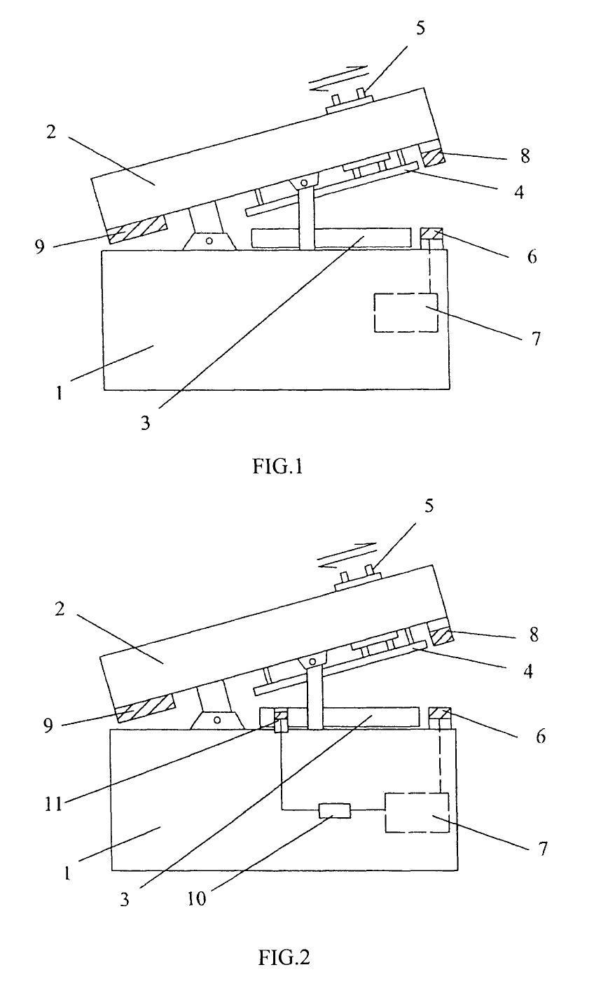

As shown in FIG. 1, the present screen printing machine mainly comprises a printing frame 1, a screen frame 2 and a locking device. The printing frame 1 is used to hold the printing stocks 3, and the printing stocks 3 could be any materials suitable for being printed, such as paper, plastics, metals, ceramics or semi-conductive materials. In addition, the printing frame 2 is used to support a screen 4 and a squeegee 5, in which the squeegee 5 is movable on the screen 4 along the directions indicated by the arrows in the figure. Thus, printing ink on the screen could be transferred to the printing stocks through openings of the screen. The screen frame 2 may be closed and opened with respect to the printing frame 1, to enable to change the printing stocks 3 and/or screen 4. FIG. 1 illustrates a hinged type screen printing machine, in which the screen frame 2 is rotatable in relation to the printing frame 1, to enable the opening and closing of the screen frame with respect to the latter. The other components of the present screen printing machine are identical to those of the existing screen printing machine, and would not be described in details herein.

The locking device of the present screen printing machine comprises a first electromagnetic member 6 being mounted on one of the printing frame 1 and the screen frame 2 and connected to a power source 7 to enable to generate an electromagnetic field upon supplied with power by the power source 7, and an attracted member 8 being mounted on the other one of the printing frame 1 and the screen frame 2 in opposite to the first electromagnetic member 6 and being attracted by the first electromagnetic member 6 when the latter generates an electromagnetic field. In the example of FIG. 1, the first electromagnetic member 6 is mounted on the printing frame 1, and the attracted member 8 is mounted on the screen frame 2. The first electromagnetic member 6 could be a direct current or alternating current electromagnet (or solenoid). When a direct or alternating current is supplied to coils of the electromagnet, the electromagnet could generate an electromagnetic field. The attracted member 8 could be made of ferrite magnetic materials, such as iron, steel, nickel, cobalt, or alloys thereof.

The operation of the screen printing machine is as follows. After the printing stocks 3 and the screen 4 are supported on the printing frame 1 and the screen frame 2 respectively, the screen frame 2 is moved towards the printing frame 1. After the screen frame 2 is closed with respect to the printing frame 1, the power source 7 is turned on to supply power to the first electromagnetic member 6, to enable the first electromagnetic member 6 to generate an electromagnetic field for attracting the attracted member 8. Thus, a locking force suitable for printing is generated between the printing frame 1 and the screen frame 2. When printing is finished, the power source 7 is turned off to stop supplying power to the first electromagnetic member 6. Thus, the attractive force of the first electromagnetic member 6 to the attracted member 8 disappears, and the printing frame 1 and the screen frame 2 are unlocked. At this time, the screen frame 2 could be opened smoothly and easily.

To adjust the locking force, the power source 7 could be a controllable power source. When a larger locking force is needed, the power source 7 is controlled to supply a higher current to the first electromagnetic member 6, to enable the first electromagnetic member 6 to generate a stronger electromagnetic field. Thus, a larger attractive force could be generated, and in turn a larger locking force could be generated between the printing frame 1 and the screen frame 2. In contrary, when a smaller locking force is needed, a lower current should be supplied to the first electromagnetic member 6.

Preferably, the attracted member 8 could be a second electromagnetic member similar to the first electromagnetic member. The second electromagnetic member is connected to the power source 7 in opposite phase with respect to the first electromagnetic member. The power source 7 could supply or stop supplying power to the first and second electromagnetic members simultaneously. Thus, when the screen frame 7 is closed with respect to the printing frame 1 and the power source 7 is turned on, the power source 7 could supply power to the first and second electromagnetic members simultaneously. Since the first and second electromagnetic members are connected to the power source in opposite phase, the adjacent ends of the first and second electromagnetic members will form opposite magnetic poles and attract each other. When the printing is finished and the power source 7 stops supplying power, the electromagnetic fields generated by the first and second electromagnetic member will disappear. Thus, the first and second electromagnetic members will not attract each other, and then the printing frame and the screen frame will be unlocked.

In addition, when the weight of the screen frame 2 is relatively heavy, a counter-weight 9 could be provided, to balance part of the weight of the screen frame 2. This is the prior art in this field and will not be described in details.

FIG. 1 only illustrates a single locking device mounted at the front part of the screen printing machine. However, to raise and uniform the locking force between the printing frame and the screen frame, two or more locking devices could be provided along the opposite sides between the printing frame and the screen frame.

FIG. 2 illustrates the second embodiment of the present screen printing machine. The second embodiment is different from the first embodiment in that, the locking device of the second embodiment further comprises a controller 10 and a sensor 11. When the screen frame 2 presses against the printing frame 1 completely and the printing is finished, the sensor 11 could be triggered to send a signal to the controller 10. The controller 10 is connected to the power source 7, and could control the power source 7 to selectively supply power to the first electromagnetic member 6 according to the signal received from the sensor 11.

As an example, the controller 10 may be a relay with normally-open contacts, while the sensor 11 could be a first limit switch (as shown in FIG. 2) provided between the printing frame 1 and the screen frame 2 and a second limit switch (not shown in the figures) provided at the end of the travel path of the squeegee 5. When the screen frame 2 moves towards the printing frame 1 and presses against the latter finally, the first limit switch is triggered. At this time, the normally-open contacts is closed, and thus the power source 7 starts to supply power to the first electromagnetic member 6, to enable the first electromagnetic member 6 to generate electromagnetic force to attract the attracted member 8. Then, a locking force is generated between the printing frame 1 and the screen frame 2. Next, when the printing is finished, the squeegee 5 moves to the end of its travel path to trigger the second limit switch. Thus, the normally-open contacts of the relay are opened, and consequently the power source 7 stops supplying power to the first electromagnetic member 6. Thus, the attractive force of the first electromagnetic member 6 to the attracted member 8 disappears, and the printing frame 1 and the screen frame 2 are unlocked. Therefore, the screen frame 2 could be opened smoothly and easily.

In addition, the controller 10 could be any suitable controller known in the field of the art, such as a single-chip microcontroller. Furthermore, besides the above-mentioned mechanical sensor, the sensor 11 could also be an optical sensor, an optoelectronical sensor or other kind of sensor known in the field of the art.

Similar to the first embodiment, the attracted member 8 of the second embodiment could also be a second electromagnetic member, and the power source 7 could supply power to the first and second electromagnetic members simultaneously under the control of the controller 10. Similarly, in the second embodiment, two or more locking devices could be provided between opposite sides between the printing frame and the screen frame, to raise and uniform the locking force between the printing frame and the screen frame. In addition, a counter-weight 9 could be provided for the screen frame 2 of the second embodiment, to balance part of the weight of the screen frame 2.

The second embodiment of the present invention could automatically control the locking device, and the automatic level of the present screen printing machine could be improved and the printing speed could be raised accordingly. The locking device applies locking force when the sensor determines that the screen frame completely presses against the printing frame. Thus, the present invention could ensure personal safety of the users.

As mentioned above, the screen printing machine may be of a vertical elevating type, a hinged type, an inclined elevating type or a horizontal movement type. The main difference among those types of screen printing machines is only in the movement manner of the screen frame with respect to the printing frame. Thus, although the above description only illustrates several embodiments of the present invention by using hinged type screen printing machines as examples, the present invention could also be used in vertical elevating type, inclined elevating type or horizontal movement type screen printing machines without significant modification to the structure and operation principle of the present invention.

Although the description of the present invention is made with reference to the preferred embodiments, the present invention is not limited to these embodiments. Various modifications and changes can be made to the invention by those skilled in the art without departing from the spirit and scopes of the present invention.

1. A screen printing machine, comprising:
a printing frame for holding printing stocks;
a screen frame for supporting a screen and a squeegee and being movable with respect to the printing frame to enable the opening and closing of the screen frame with respect to the printing frame; and
at least one locking device including a first electromagnetic member and an attracted member, in which the first electromagnetic member is mounted on one of the printing frame and the screen frame and connected to a power source, while the attracted member is mounted on the other one of the printing frame and the screen frame in opposite to the first electromagnetic member,
wherein when the screen frame is closed with respect to the printing frame, the power source starts to supply power to the first electromagnetic member to enable the first electromagnetic member to generate an electromagnetic field and then generate an attractive force to the attracted member which locks the printing frame and the screen frame together; when the printing is finished, the power source stops supplying power to the first electromagnetic member which makes the attractive force of the first electromagnetic member to the attracted member disappear, and in turn the printing frame and the screen frame are unlocked.

2. The screen printing machine according to claim 1, wherein the locking device further comprises a controller and a sensor, in which the sensor is provided to be triggered to send a signal to the controller when the screen frame is closed to the printing frame completely and the printing is finished; and the controller is connected to the power source and controls the power source to selectively supply power to the first electromagnetic member according to the signal received from the sensor.

3. The screen printing machine according to claim 1, wherein the attracted member is made of ferrite magnetic materials.

4. The screen printing machine according to claim 1, wherein the attracted member is a second electromagnetic member, in which the second electromagnetic member is connected to the power source in opposite phase with respect to the first electromagnetic member, and the power source could supply power to the first and second electromagnetic members simultaneously.

5. The screen printing machine according to claim 1, wherein the said at least one locking device is two or more locking devices provided along opposite sides between the printing frame and the screen frame.

6. The screen printing machine according to claim 1, further comprising a counter-weight for balancing part of the weight of the screen frame.

7. A locking device used in a screen printing machine, in which the screen printing machine comprises a printing frame for holding printing stocks and a screen frame for supporting a screen and a squeegee and being movable with respect to the printing frame to enable the opening and closing of the screen frame with respect to the printing frame, and the locking device comprises:
a first electromagnetic member mounted on one of the printing frame and the screen frame and connected to a power source;
an attracted member mounted on the other one of the printing frame and the screen frame in opposite to the first electromagnetic member,
wherein when the screen frame is closed with respect to the printing frame, the power source starts to supply power to the first electromagnetic member to enable the first electromagnetic member to generate an electromagnetic field and then generate an attractive force to the attracted member which locks the printing frame and the screen frame together; when the printing is finished, the power source stops supplying power to the first electromagnetic member which makes the attractive force of the first electromagnetic member to the attracted member disappear, and in turn the printing frame and the screen frame are unlocked.

8. The locking device according to claim 7 further comprising a controller and a sensor, in which the sensor is provided to be triggered to send a signal to the controller when the screen frame is closed to the printing frame completely and the printing is finished; and the controller is connected to the power source and controls the power source to selectively supply power to the first electromagnetic member according to the signal received from the sensor.

9. The locking device according to claim 7, wherein the attracted member is made of ferrite magnetic materials.

10. The locking device according to claim 7, wherein the attracted member is a second electromagnetic member, in which the second electromagnetic member is connected to the power source in opposite phase with respect to the first electromagnetic member, and the power source could supply power to the first and second electromagnetic members simultaneously.

11. The screen printing machine according to claim 2, wherein the attracted member is made of ferrite magnetic materials.

12. The screen printing machine according to claim 2, wherein the attracted member is a second electromagnetic member, in which the second electromagnetic member is connected to the power source in opposite phase with respect to the first electromagnetic member, and the power source could supply power to the first and second electromagnetic members simultaneously.

13. The screen printing machine according to claim 2, wherein the said at least one locking device is two or more locking devices provided along opposite sides between the printing frame and the screen frame.

14. The screen printing machine according to claim 2 further comprising a counter-weight for balancing part of the weight of the screen frame.

15. The locking device according to claim 8, wherein the attracted member is made of ferrite magnetic materials.

16. The locking device according to claim 8, wherein the attracted member is a second electromagnetic member, in which the second electromagnetic member is connected to the power source in opposite phase with respect to the first electromagnetic member, and the power source could supply power to the first and second electromagnetic members simultaneously.
